(19) United States
(12) Patent Application Publication
(10) Pub. No.: US 2026/0158349 A1
(43) Pub. Date: Jun. 11, 2026

(54) PORTABLE BASKETBALL ASSEMBLY

(71) Applicant: Jerry Gerald Buchinger, Batavia, NY (US)

(72) Inventor: Jerry Gerald Buchinger, Batavia, NY (US)

(21) Appl. No.: 18/977,116

(22) Filed: Dec. 11, 2024

(51) Int. Cl. A63B 63/08; A63B 71/02

(52) U.S. Cl. CPC A63B 63/083; A63B 71/023; A63B 2225/093

(57) ABSTRACT

A portable basketball assembly to attach to a tailgate of a vehicle, the portable basketball assembly including a tailgate bracket to attach to the tailgate of the vehicle, a pole to connect to a top portion of the tailgate bracket at a bottom portion of the pole, and a hoop assembly to connect to a top portion of the pole.

### BACKGROUND

### 1. Field

The present general inventive concept relates generally to a basketball assembly, and particularly, to a portable basketball assembly.

### 2. Description of the Related Art

Basketball is a beloved sport by diverse populations; yet, to play, the task of finding a suitable space can be challenging.

In many urban or suburban areas, public courts may be overcrowded, poorly maintained, or simply not conveniently located; thus, limiting play access to participants due to basketball's fixed equipment and formal space requirements.

Therefore, there is a need for a portable device that allows people to play basketball at various locations.

### SUMMARY

The present general inventive concept provides a portable basketball assembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable basketball assembly to attach to a tailgate of a vehicle, the portable basketball assembly including a tailgate bracket to attach to the tailgate of the vehicle, a pole to connect to a top portion of the tailgate bracket at a bottom portion of the pole, and a hoop assembly to connect to a top portion of the pole.

The tailgate bracket may include a bracket top disposed at a top portion of the tailgate bracket, a bracket inner support disposed at a first side of the tailgate bracket to contact an inner surface of the tailgate of the vehicle, a bracket outer support disposed at a second side of the tailgate bracket to contact an outer surface of the tailgate of the vehicle, and a bracket pole connector disposed on a top surface of the bracket top to connect to a first end of the pole.

The bracket inner support may extend downward from a portion of the bottom surface of the bracket top, and the bracket outer support may extend downward from another portion of the bottom surface of the bracket top.

The hoop assembly may include a hoop assembly pole connector disposed at a bottom portion of the hoop assembly to connect to a second end of the pole.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a portable basketball assembly, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Portable Basketball Assembly 100
Hoop Assembly 110
Backboard 111
Hoop 112
Net 113
Hoop Assembly Pole Connector 114
Pole 120
Pole First Section 121
Pole Second Section 122
Pole Third Section 123
Tailgate Bracket 130
Bracket Top 131
Bracket Inner Support 132
Bracket Outer Support 133
Bracket Pole Connector 134

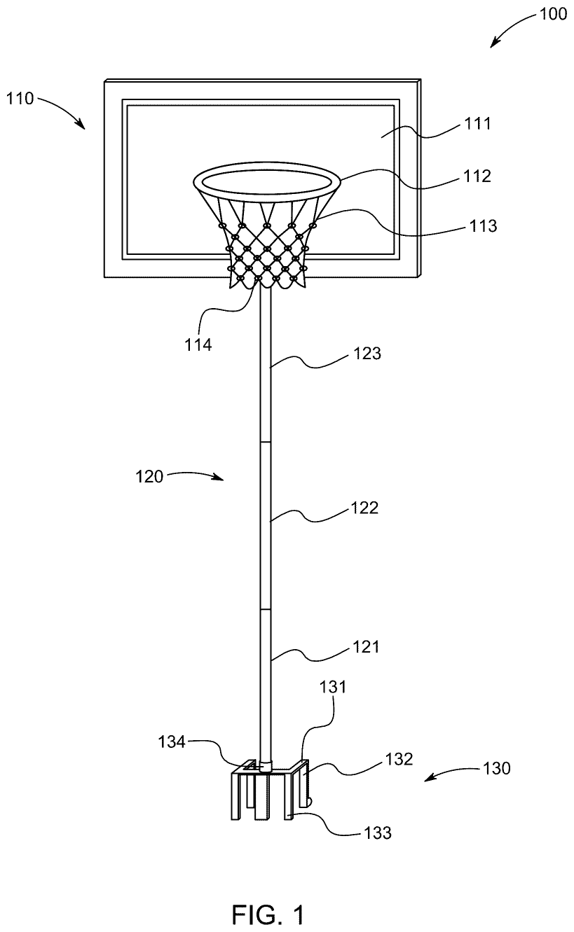

FIG. 1 illustrates a portable basketball assembly 100, according to an exemplary embodiment of the present general inventive concept.

The portable basketball assembly 100, and all components therein and/or connected thereto, may be constructed from at least one of metal, plastic, stone, ceramics, wood, silicone, liquid, gel, glass, paper, cloth, circuitry, leather, memory foam, latex, and rubber, etc., but is not limited thereto, and can be constructed from any material known to one of ordinary skill in the art.

Referring to FIG. 1, the portable basketball assembly 100 may include a hoop assembly 110, a pole 120, and a tailgate bracket 130, but is not limited thereto.

The hoop assembly 110 may be configured to attached to the pole 120 at a top portion of the pole 120, and the tailgate bracket 130 may be configured to be attached to the pole 120 at a bottom portion of the pole 120.

The hoop assembly 110 may include a backboard 111, a hoop 112, a net 113, and a hoop assembly pole connector 114, but is not limited thereto.

The backboard 111 may be any type of basketball backboard known to one of ordinary skill in the art.

The hoop 112 may be any type of hoop known to one of ordinary skill in the art, and may be attached to the backboard 111.

The net 113 may be any type of net known to one of ordinary skill in the art.

The hoop assembly pole connector 114 may be disposed at a bottom portion of the backboard 111, and may receive at least a portion of the pole 120 therein so that the pole 120 is connected to the backboard 111.

The pole 120 may include a pole first section 121, a pole second section 122, and a pole third section 123, but is not limited thereto, and may include any number of pole sections of varying sizes to allow for adjustability of a height of the pole 120.

The pole first section 121 may be a bottommost section of the pole 120, and may be attached to the tailgate bracket 130 at a first end thereof, and may be attached to a first end of the pole second section 122 at a second end thereof. A second end of the pole second section 122 may be attached to a first end of the pole third section 123, which may be a topmost section of the pole 120, and which may have a second end attached to the hoop assembly pole connector 114.

The various pole sections may be attached to (a.k.a., connected to) each other by screwing the end portions thereof into each other, but screwing is not the only method of attachment, and the various pole sections may be attached to each other in any manner known to one of ordinary skill in the art.

The second end of the pole third section 123 may be screwed into the hoop assembly pole connector 114, but is not limited thereto, and may be attached to the hoop assembly pole connector 114 in any manner known to one of ordinary skill in the art.

The tailgate bracket 130 may include a bracket top 131, a bracket inner support 132, a bracket outer support 133, and a bracket pole connector 134, but is not limited thereto.

The bracket pole connector 134 may receive at least a potion of the pole 120 there inside to that the pole 120 is connected to the bracket pole connector 134. Specifically, the pole first section 121 may be attached to (a.k.a., connected to) a second end of the pole first section 121.

The second end of the pole first section 121 may be screwed into the bracket pole connector 134, but is not limited thereto, and may be attached to the bracket pole connector 134 in any manner known to one of ordinary skill in the art.

The bracket pole connector 134 may be disposed at a top surface of the bracket top 131.

The bracket inner support 131 may be provided singularly or in plurality, and may be connected to a first side of the bracket top 131 so that the bracket inner support 131 may attach to an inner surface of a tailgate of a vehicle.

The bracket outer support 132 may be provided singularly or in plurality, and may be connected to a second side of the bracket outer support 132 so that the bracket outer support 132 may attach to an outer surface of a tailgate of a vehicle.

As such, the tailgate bracket 130 may be attached to a tailgate of a vehicle so that people may play basketball at any location where the vehicle is located.

The present general inventive concept may include a portable basketball assembly 100 to attach to a tailgate of a vehicle, the portable basketball assembly 100 including a tailgate bracket 130 to attach to the tailgate of the vehicle, a pole 120 to connect to a top portion of the tailgate bracket 130 at a bottom portion of the pole 120, and a hoop assembly 110 to connect to a top portion of the pole 120.

The tailgate bracket 130 may include a bracket top 131 disposed at a top portion of the tailgate bracket 130, a bracket inner support 132 disposed at a first side of the tailgate bracket 130 to contact an inner surface of the tailgate of the vehicle, a bracket outer support 133 disposed at a second side of the tailgate bracket 130 to contact an outer surface of the tailgate of the vehicle, and a bracket pole connector 134 disposed on a top surface of the bracket top 131 to connect to a first end of the pole 120.

The bracket inner support 132 may extend downward from a portion of the bottom surface of the bracket top 131, and the bracket outer support 133 may extend downward from another portion of the bottom surface of the bracket top 131.

The hoop assembly 110 may include a hoop assembly pole connector 134 disposed at a bottom portion of the hoop assembly 110 to connect to a second end of the pole 120.

A main purpose of the present general inventive concept is to provide a portable and versatile automotive accessory, for basketball enthusiasts, that permits them to define a court at various locations. Ingenious and practical, the present general inventive concept introduces a novel car accessory that permits a user to independently define a space, as a half court or full court, basketball play area. Designed for simplicity and quick set-up via the act of mounting the system on the tailgate of any pickup truck, the present general inventive concept allows for the installation of a glass back basketball hoop, instantly transforming any suitable space into a basketball court. This innovation effectively makes basketball more accessible and convenient, whether it's in driveways, parking lots, or other flat surfaces. The present general inventive concept permits the “court” to be expanded, at will, as users can affix the primary accessory on two separate pickup trucks, to create a full basketball court that can accommodate larger groups and formal games. The adjustable height feature of the basketball pole adds flexibility, catering to different players and skill levels, providing versatility with utilization that ensures an inclusive playing experience, enhancing accessibility for a wider range of players. Additionally, the portability of the system—where this compact basketball device can be carried in the back of a pickup truck—enhances its appeal for spontaneous games or structured organized events. In essence, the present general inventive concept aims to democratize basketball play by offering a portable, easy-to-set-up and dismantle solution that can turn almost any location: a driveway, parking lot, or open field, into a defined basketball court, thereby promoting physical activity, social interaction, and the enjoyment of the sport. As a result, the present general inventive concept may prove beneficial in the novelty/sports industry.

The present general inventive concept is truly unique as has an innate ability to define a mobile basketball court with a mounted glass back basketball hoop with the complement of any pickup truck for mounting support as its only necessity. This innovative design negates the traditional requirement for a designated gym and/or court possessing fixed installations to engage in a game of basketball as it provides a feasible means for users to set up and dismantle a basketball hoop, quickly and efficiently, wherever they may choose to play.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A portable basketball assembly to attach to a tailgate of a vehicle, the portable basketball assembly comprising:
a tailgate bracket to attach to the tailgate of the vehicle;
a pole to connect to a top portion of the tailgate bracket at a bottom portion of the pole; and
a hoop assembly to connect to a top portion of the pole.

2. The portable basketball assembly of claim 1, wherein the tailgate bracket comprises:
a bracket top disposed at a top portion of the tailgate bracket;
a bracket inner support disposed at a first side of the tailgate bracket to contact an inner surface of the tailgate of the vehicle;
a bracket outer support disposed at a second side of the tailgate bracket to contact an outer surface of the tailgate of the vehicle; and
a bracket pole connector disposed on a top surface of the bracket top to connect to a first end of the pole.

3. The portable basketball assembly of claim 2, wherein
the bracket inner support extends downward from a portion of the bottom surface of the bracket top; and
the bracket outer support extends downward from another portion of the bottom surface of the bracket top.

4. The portable basketball assembly of claim 2, wherein the hoop assembly comprises:
a hoop assembly pole connector disposed at a bottom portion of the hoop assembly to connect to a second end of the pole.
